(19) United States
(12) Patent Application Publication
(10) Pub. No.: US 2024/0212148 A1
(43) Pub. Date: Jun. 27, 2024

(54) SYSTEMS AND METHODS FOR SHARPENING MEDICAL IMAGES

(71) Applicant: Stryker Corporation, Kalamazoo, MI (US)

(72) Inventors: Donna HOHERTZ, Vancouver (CA); Paul Roald WESTWICK, Vancouver (CA)

(73) Assignee: Stryker Corporation, Kalamazoo, MI (US)

(21) Appl. No.: 18/542,547

(22) Filed: Dec. 15, 2023

Related U.S. Application Data
(60) Provisional application No. 63/477,146, filed on Dec. 23, 2022.

(51) Int. Cl. G06T 7/00; G06T 5/73

(52) U.S. Cl. CPC G06T 7/0012; G06T 5/73

(57) ABSTRACT

A method for sharpening a medical image including receiving the medical image; and generating a sharpened medical image from the medical image using at least: a first sharpening function for at least some areas of local contrast magnitude in the medical image that are below a first local contrast magnitude threshold for suppressing sharpening of noise-based contrast, a second sharpening function for at least some areas of local contrast magnitude in the medical image that are between the first local contrast magnitude threshold and a second local contrast magnitude threshold, and a third sharpening function for at least some areas of local contrast magnitude in the medical image that are above the second local contrast magnitude threshold for attenuating sharpening relative to the second sharpening function.

### CROSS-REFERENCE TO RELATED APPLICATIONS

This application claims the benefit of U.S. Provisional Application No. 63/477,146, filed Dec. 23, 2022, the entire contents of which are hereby incorporated by reference herein.

### FIELD

The present disclosure is related to medical imaging, and in particular, to image processing for medical imaging.

### BACKGROUND

Minimally invasive surgery generally involves the use of a high-definition camera coupled to an endoscope inserted through a small incision into a patient to provide a surgeon with a clear and precise view within the body with minimal tissue damage. The endoscope emits light from its distal end to illuminate the surgical cavity, receives light reflected or emitted by tissue within the surgical cavity, and directs the received light to the camera. Effectively illuminating the surgical cavity for imaging can be challenging. The confined nature of the surgical cavity and the unidirectional illumination provided by the endoscope often leads to inconsistent illumination of the surgical field. As a result, the surgical cavity is often not optimally illuminated for endoscopic imaging. Furthermore, the small aperture of endoscopic imaging devices typically results in imaging that is diffraction limited and lacking in sharpness. A small aperture may also be used with open field imaging devices to help compensate for room light artifacts. Open-field imaging can also suffer from shadowed regions with poor illumination. Image processing techniques known in the field of imaging can be used to improve the quality of images. For example, sharpening can be used to increase the contrast between light and dark sides of edges, making the feature in the image more clearly discernable. However, sharpening can create distortions that lead to an unnatural appearance.

### SUMMARY

According to an aspect, systems and methods include sharpening a medical image using different sharpening functions for different ranges of local contrast. The different functions can provide desirable levels of sharpening of tissue while not over-sharpening already sharp features or significantly increasing low-contrast noise. A medical image may be converted to a luminance image and a local contrast map may be calculated by subtracting a blurred luminance image from the luminance image. For each pixel, a sharpening factor is determined using a sharpening function that is tailored to the range of local contrasts that includes the local contrast for that pixel. A sharpened luminance image is then computed based on the original luminance image and the sharpening factor and local contrast for each pixel.

According to an aspect, a method for sharpening a medical image includes receiving the medical image; and generating a sharpened medical image from the medical image using at least: a first sharpening function for at least some areas of local contrast magnitude in the medical image that are below a first local contrast magnitude threshold for suppressing sharpening of noise-based contrast, a second sharpening function for at least some areas of local contrast magnitude in the medical image that are between the first local contrast magnitude threshold and a second local contrast magnitude threshold, and a third sharpening function for at least some areas of local contrast magnitude in the medical image that are above the second local contrast magnitude threshold for attenuating sharpening relative to the second sharpening function.

The first, second, and third sharpening functions may be used for sharpening a luminance channel of the medical image.

The local contrast magnitude may include an absolute value of a difference between a luminance and a blurred luminance.

The second sharpening function may be a linear function. The first and third sharpening functions may be non-linear functions.

At least one of the first sharpening function, the second sharpening function, and the third sharpening function may include a user defined sharpening factor.

Each of the first sharpening function, the second sharpening function, and the third sharpening function may include the user defined sharpening factor.

The first sharpening function may include a gain factor that corresponds to gain applied for generating the medical image.

The sharpened medical image may be generated using a fourth sharpening function for areas of local contrast magnitude that are above a third local contrast magnitude threshold that is higher than the second local contrast magnitude threshold.

The second local contrast magnitude threshold may be associated with attenuating sharpening of at least one of specular reflections and medical instruments.

The method may include, for a respective pixel of the medical image: computing a sharpening value based on a local contrast associated with the respective pixel and the first, second, or third sharpening function; in accordance with the local contrast being positive, using the sharpening value to increase a brightness value for the respective pixel by a first amount; and in accordance with the local contrast being negative, using the sharpening value to decrease the brightness value for the respective pixel by a second amount that is less than the first amount would have been had the local contrast been positive.

According to an aspect, a method for sharpening a medical image includes receiving the medical image; and generating a sharpened medical image, wherein generating the sharpened medical image comprises, for each pixel of the medical image: computing a sharpening value for the respective pixel based on a local contrast associated with the respective pixel and at least one sharpening function, in accordance with the local contrast being positive, using the sharpening value for the respective pixel to increase a brightness value for the respective pixel by a first amount, and in accordance with the local contrast being negative, using the sharpening value for the respective pixel to decrease the brightness value for the respective pixel by a second amount that is less than the first amount would have been had the local contrast been positive.

The local contrast associated with the respective pixel may include a signed difference between a luminance and a blurred luminance.

The at least one sharpening function may include multiple sharpening functions, each used for a different range of local contrasts.

The brightness value may be a brightness value for a luminance channel of the medical image.

The first amount may be defined by a first function and the second amount is defined by a second function that is different than and proportional to the first function. The second amount may be proportional to the local contrast and to the original brightness value for the respective pixel.

A brightness value for a sharpened image pixel associated with a negative local contrast may be a quotient of: (a) the square of a corresponding brightness value of the medical image, and (b) a difference between the corresponding brightness value of the medical image and the sharpening value. A brightness value for a sharpened image pixel associated with a positive local contrast may be the sum of the sharpening value and a corresponding brightness value of the medical image.

According to an aspect, a system for sharpening a medical image includes one or more processors, memory, and one or more programs stored in the memory for execution by the one or more processors, wherein the one or more programs include instructions that when executed by the one or more processors cause the system to: receive the medical image; and generate a sharpened medical image from the medical image using at least: a first sharpening function for at least some areas of local contrast magnitude in the medical image that are below a first local contrast magnitude threshold for suppressing sharpening of noise-based contrast, a second sharpening function for at least some areas of local contrast magnitude in the medical image that are between the first local contrast magnitude threshold and a second local contrast magnitude threshold, and a third sharpening function for at least some areas of local contrast magnitude in the medical image that are above the second local contrast magnitude threshold for attenuating sharpening relative to the second sharpening function.

The first, second, and third sharpening functions may be used for sharpening a luminance channel of the medical image.

The local contrast magnitude may include an absolute value of a difference between a luminance and a blurred luminance.

The second sharpening function may be a linear function. The first and third sharpening functions may be non-linear functions.

At least one of the first sharpening function, the second sharpening function, and the third sharpening function may include a user defined sharpening factor.

Each of the first sharpening function, the second sharpening function, and the third sharpening function may include the user defined sharpening factor.

The first sharpening function may include a gain factor that corresponds to gain applied for generating the medical image.

The sharpened medical image may be generated using a fourth sharpening function for areas of local contrast magnitude that are above a third local contrast magnitude threshold that is higher than the second local contrast magnitude threshold.

The second local contrast magnitude threshold may be associated with attenuating sharpening of at least one of specular reflections and medical instruments.

The one or more programs may include instructions for, for a respective pixel of the medical image: computing a sharpening value based on a local contrast associated with the respective pixel and the first, second, or third sharpening function; in accordance with the local contrast being positive, using the sharpening value to increase a brightness value for the respective pixel by a first amount; and in accordance with the local contrast being negative, using the sharpening value to decrease the brightness value for the respective pixel by a second amount that is less than the first amount would have been had the local contrast been positive.

According to an aspect, a system for sharpening a medical image includes one or more processors, memory, and one or more programs stored in the memory for execution by the one or more processors, wherein the one or more programs include instructions that when executed by the one or more processors cause the system to: receive the medical image; and generate a sharpened medical image, wherein generating the sharpened medical image comprises, for each pixel of the medical image: computing a sharpening value for the respective pixel based on a local contrast associated with the respective pixel and at least one sharpening function, in accordance with the local contrast being positive, using the sharpening value for the respective pixel to increase a brightness value for the respective pixel by a first amount, and in accordance with the local contrast being negative, using the sharpening value for the respective pixel to decrease the brightness value for the respective pixel by a second amount that is less than the first amount would have been had the local contrast been positive.

The local contrast associated with the respective pixel may include a signed difference between a luminance and a blurred luminance.

The at least one sharpening function may include multiple sharpening functions, each used for a different range of local contrasts.

The brightness value may be a brightness value for a luminance channel of the medical image.

The first amount may be defined by a first function and the second amount is defined by a second function that is different than and proportional to the first function. The second amount may be proportional to the local contrast and to the original brightness value for the respective pixel.

A brightness value for a sharpened image pixel associated with a negative local contrast may be a quotient of: (a) the square of a corresponding brightness value of the medical image, and (b) a difference between the corresponding brightness value of the medical image and the sharpening value. A brightness value for a sharpened image pixel associated with a positive local contrast may be the sum of the sharpening value and a corresponding brightness value of the medical image.

According to an aspect, a non-transitory computer readable storage medium storing one or more programs for execution by one or more processors of a computing system, the one or more programs including instructions that when executed by the one or more processors cause the computing system to perform any of the above methods.

It will be appreciated that any of the variations, aspects, features and options described in view of the systems apply equally to the methods and vice versa. It will also be clear that any one or more of the above variations, aspects, features and options can be combined.

### BRIEF DESCRIPTION OF THE FIGURES

The invention will now be described, by way of example only, with reference to the accompanying drawings, in which:

FIG. 1 is a block diagram of an exemplary endoscopic imaging system;

FIG. 2 is a flow diagram of an exemplary method for sharpening a medical image;

FIGS. 3A and 3B illustrate a set of exemplary sharpening curves that may be used to sharpen a medical image;

FIGS. 4A and 4B illustrate a set of exemplary curves generated using a higher gain value than the gain value used for the curves of FIGS. 3A and 3B;

FIG. 5 is a simplistic representation of an example of sharpening the dark and light sides of an edge;

FIG. 6 is a flow diagram of an exemplary method for sharpening a medical image using different functions for applying sharpening to the bright and dark sides of edges; and

FIG. 7 illustrates an example of a computing system.

### DETAILED DESCRIPTION

Reference will now be made in detail to implementations and examples of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Systems and methods, aspects of which are illustrated herein, include sharpening of medical images using sharpening curves that sharpen anatomical features while not over-sharpening already sharp features or significantly increasing noise. Surgical scenes feature many relatively low contrast structures like tissue. Conventional sharpening algorithms tuned to target these features tend to over-sharpen high contrast objects in the field such as surgical tools and specular reflections while adding unwanted noise in very low contrast areas of the field of view that are associated with noise. Described herein is medical image sharpening using sharpening curves in which sharpening is dependent upon on local contrast, which provides desirable levels of sharpening of tissue while not over-sharpening already sharp features or significantly increasing low-contrast noise. The sharpening curves can include a noise suppression section that is applied to areas of very low contrast typically associated with noise, a tissue-enhancement section that is applied to areas of low contrast typically associated with tissue, and a sharpening attenuation section that is applied to areas of high contrast such those associated with tools and specular reflections. The noise suppression section is configured to suppress sharpening of low-contrast areas associated with noise in the image. The tissue-enhancement section targets sharpening of regions of tissue by providing a degree of sharpening that is suitable for tissue. The sharpening attenuation section attenuates sharpening of high contrast features. Sharpening curves may also include a section of minimum sharpening to which the curves converge at sufficiently high local contrast.

Sharpening of medical images can include generating a luminance image (the set of brightness values for the pixels of the medical image) from a color image using a suitable color space conversion. A “blurred” luminance image is generated from the luminance image. The blurred luminance image provides local measures of average brightness. The blurred luminance image can be generated using a blurring operation such as a Gaussian blur or box filter. A local contrast map is calculated by subtracting the blurred luminance image from the luminance image. For each pixel location, a sharpening factor is determined using a sharpening curve and the local contrast for the pixel location. The sharpened luminance image is then computed based on the original luminance image, the sharpening factor, and the local contrast for each pixel location.

The sharpening curve provides a sharpening factor as a function of local contrast. A sharpening curve may be implemented as a function that outputs a sharpening factor for an input of local contrast or may be implemented as a lookup table that provides a sharpening factor for each value of local contrast. Optionally, the sharpening factor may be a function of a global multiplier associated with a user-settable sharpening setting that enables the user to control the degree of sharpening.

As explained above, a sharpening curve can have different sections for applying different relationships between sharpening and local contrast for different ranges of local contrast. Transitions between different sections of the curve can be selected according to the expected local contrast for noise, anatomical regions, and/or high contrast features such as instruments and spectral reflections that may often appear in medical imaging. For example, the transition between the noise suppression section of the curve and the tissue enhancement section of the curve may be based on a low end of a range of expected local contrast values associated with tissue and the transition between the tissue enhancement section of the curve and the sharpening attenuation section may be based on a high end of a range of expected local contrast values associated with tissue. Different curves may be used for different gains such that sharpening is a function of gain.

Curves may be continuous with continuous derivatives so that no small change in local contrast causes a large change in sharpening. Curves can be configured such that sharpness always increases with increasing local contrast value. Thus, areas that have higher contrast in the original image should still have higher contrast in the enhanced image. Curves can be configured such that sharpness is greater for a greater global multiplier such that increasing the user-settable sharpening setting increases the sharpness of all parts of the image.

Optionally, the sharpening factor determined based on a sharpening curve may be applied proportionally to the value of the local contrast such that edge enhancement is more perceptually uniform. In conventional sharpening, the same amount of sharpening is added to the light side of an edge as is subtracted from the dark side of the edge, which tends to enhance the appearance of undershoot. Instead of applying the sharpening derived from the curves discussed herein in this conventional way, sharpening can be applied so that the relative ratio of over- and under-shoot is substantially similar, which can reduce the presence of unnatural undershoot artifacts.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

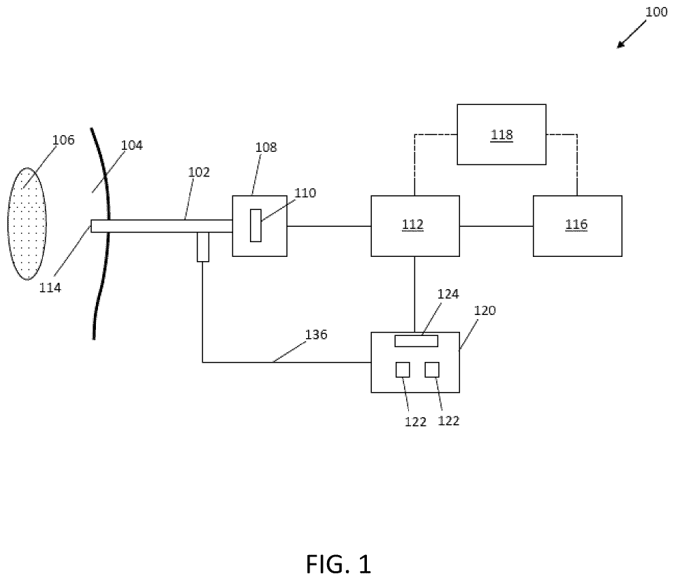

FIG. 1 illustrates an exemplary system 100 for endoscopic imaging that may be used to capture medical images and apply the sharpening techniques described herein to enhance the medical images. System 100 includes an endoscope 102 for insertion into a surgical cavity 104 for imaging tissue 106 within the surgical cavity 104 during a medical procedure and an illuminator 120 that provides illumination light to the endoscope 102, which emits the light from its distal end 114 for illuminating the tissue 106.

The endoscope 102 may extend from an endoscopic camera head 108 that includes one or more imaging sensors 110. As is well known in the art, light reflected and/or emitted (such as fluorescence light emitted by fluorescing targets that are excited by fluorescence excitation illumination light) from the tissue 106 is received by the distal end 114 of the endoscope 102. The light is propagated by the endoscope 102, such as via one or more optical components (for example, one or more lenses, prisms, light pipes, or other optical components), to the camera head 108, where it is directed onto the one or more imaging sensors 110. According to various embodiments, one or more filters (not shown) may be included in the endoscope 102 and/or camera head 108 for filtering a portion of the light received from the tissue 106 (such as fluorescence excitation light).

The one or more imaging sensors 110 detect light received from the imaging field of view, including tissue 106. One or more processors of the camera head 108 or a camera control unit 112 connected to the camera head 108 convert the image signal(s) from the one or more imaging sensors 110 to digital pixel data. Where the camera head generates the digital pixel data, the digital pixel data can be transmitted to the camera control unit 112, which can process the digital pixel data to generate one or more images. As used herein “images” and “imaging data” encompasses single images and video frames. The images can be transmitted to an image processing unit 116 for further image processing, storage, display, and/or routing to an external device (not shown). One or more analog and/or digital gains can be used to control the brightness of the resulting images. For example, an analog gain can be provided by the one or more imaging sensors 110 and/or one or more digital gains can be applied by the camera head 108, camera control unit 112, and/or image processing unit 116. One or more of these gains can be automatically controlled and/or can be set by a user (or can be based on a user setting). Unless otherwise specified, “gain” as used herein refers to the combination of any imaging gains, including analog and digital gains.

The images can be transmitted to one or more displays 118, from the camera control unit 112 and/or the image processing unit 116, for visualization by medical personnel, such as by a surgeon for visualizing the field of view within the surgical cavity 104 during a surgical procedure on a patient. Optionally, one or more functions of the image processing unit 116 described herein can be performed by the camera control unit 112 and vice versa.

The illuminator 120 generates illumination light and provides the illumination light to the endoscope 102 via light guide 136, which may comprise, for example, one or more fiber optic cables, with the light guide 136 coupled to the endoscope 102 at the light post 126 in the proximal region of the endoscope. The illumination light is emitted from the distal end 114 of the endoscope 102 and illuminates the tissue 106. As used herein, “illumination light” refers to light that may be used to illuminate tissue for the purposes of imaging the tissue. The illumination light can include any desirable wavebands or combination of wavebands. At least a portion of the illumination light may be light having a waveband in the visible spectrum that is reflected by the tissue 106 and captured by the one or more imaging sensors 110 for generating reflected light imaging data. Optionally, the illumination light can be or include fluorescence excitation light for exciting one or more fluorescing targets in the tissue, which can include one or more fluorescence agents and/or one or more auto-fluorescing targets. Light emitted by the one or more fluorescence targets may be captured by the one or more imaging sensors for generating fluorescence imaging data. Optionally, visible light and fluorescence excitation light can be provided based on an operating mode, such as a visible light imaging operating mode in which the illuminator provides only visible light, a fluorescence imaging mode in which the illuminator provides only fluorescence excitation light, and/or a combined imaging mode in which both visible light and fluorescence excitation light are provided, either simultaneously or in alternating fashion.

The illuminator 120 includes one or more light sources 122 that each generate one or more wavebands of light and a controller 124 for controlling the light sources 122. The light sources 122 generate illumination light for illuminating the tissue 106 via the endoscope 102. The controller 124 can be configured to activate and deactivate the individual light sources 122 and/or adjust a power level of the light sources 122 to adjust the level of intensity (i.e., the luminance) of light generated by the individual light sources 122. The controller 124 may control one or more light sources 122 based on one or more control signals received from camera control unit 112 and/or image processing unit 116. In some embodiments, control signals received from the camera control unit 112 and/or image processing unit 116 can instruct the controller 124 how to control individual light sources 122, such as by including instructions to activate or deactivate individual light sources 122 and/or to set one or more individual light sources 122 at a specified power/intensity level. For example, the camera control unit 112 and/or image processing unit 116 may determine that a specific color and/or intensity adjustment is needed based on analysis of pixel data generated by the endoscopic camera head 108 and the controller 124 may receive instructions specifying the adjustments.

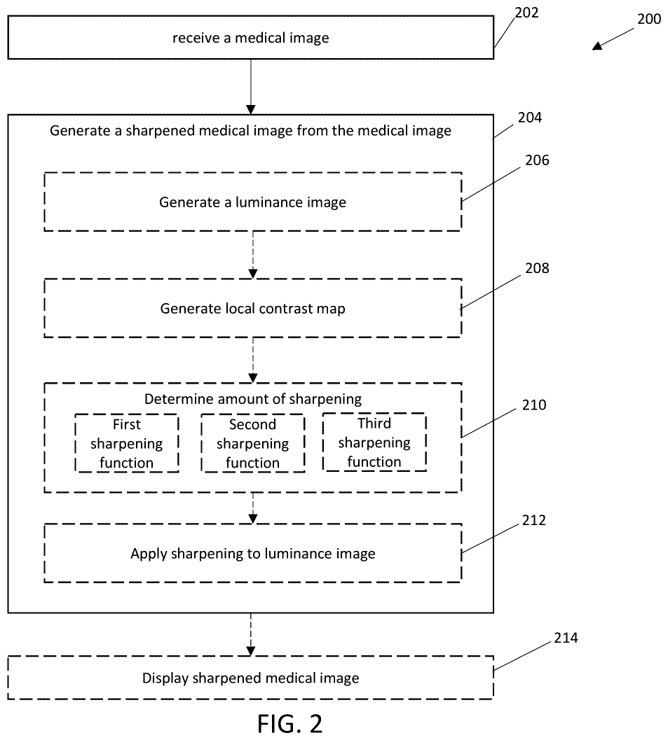

FIG. 2 illustrates a method 200 for sharpening medical imaging, according to various embodiments. Method 200 can be performed by an endoscopic imaging system, such as system 100 of FIG. 1. In particular, method 200 can be performed by an image processing unit, such as image processing unit 116 of FIG. 1. Method 200 is not limited to being performed by an endoscopic imaging system and can be performed by any suitable imaging system, including an open-field imaging system.

At step 202, a medical image is received. The medical image may be received by an image processing system from an imager or other component of an imaging system. For example, the medical image may be received by image processing unit 116 from camera control unit 112 of system 100 of FIG. 1. Additionally or alternatively, the medical image may be received from a memory in which the medical image was previously stored, such as during a previously conducted imaging session. The medical image can be a single snapshot image or can be a frame of a series of video frames that may be received frame-by-frame in a continuous fashion as the frames are generated or from a buffer in which the frames are stored in a continuous fashion as the frames are generated. The medical image may have been captured during a medical procedure, which may be an exploratory procedure, a diagnostic procedure, a study, a surgical procedure, a non-surgical procedure, an invasive procedure, or a non-invasive procedure. The medical image can be an open-field image or an endoscopic image. The medical image may be a color image or a grayscale image.

At step 204, a sharpened medical image is generated using a sharpening curve that is defined by different sharpening functions for different ranges of local contrast. The sharpening may be applied to the luminance channel of the image. As such, step 204 may include an optional step 206 of determining the luminance of each pixel location in the image by converting from, for example, the RGB color space (or some other color space) to the luminance-chrominance color space, resulting in what is referred to herein as the luminance channel or luminance image.

Sharpening may be performed on the luminance channel of the medical image according to the following relationship:

$${Image}_{Sharp} = f ( {Image}_{0} , {K}^{′} \cdot Δ I ) \qquad ( 1 )$$

Where Image sharp is a sharpened luminance image, Image, is the original luminance image, K′ is a sharpening factor, and Δ1 is the local contrast. The above relationship can be applied to each pixel. In other words, Imageₛₕₐᵣₚ for pixel x is a function of Image, for pixel x, K′ for pixel x, and 41 for pixel x. As such, step 204 may include, at optional step 208, generating a local contrast map (the set of local contrasts, Δ1) from the luminance image, as follows:

$$Δ I = ( {Image}_{0} - {Image}_{B l u r r e d} )$$

Image_{Blurred} is a “blurred” luminance image that may be generated by applying a blurring operation to the original luminance image, Imageₒ. The blurring operation computes local measures of average brightness in the original luminance image. The blurring option can be, for example, a Gaussian blur or box filter. The local contrast is a positive number for pixels that are brighter than the corresponding blurred image value and a negative number for pixels that are darker than the corresponding blurred image value.

The product K′·Δ1 defines the amount of sharpening as a function of local contrast. In conventional sharpening, a constant sharpening factor that is the same for all local contrast values is multiplied by the local contrast to determine the amount of sharpening. In contrast, according to the methods and systems described herein, the sharpening factor K′ can be a function of the local contrast for at least some ranges of local contrast. Additionally, different functions can be used to define K′ for different ranges of local contrast magnitudes (the absolute value of Δ1) to tailor sharpening to achieve different sharpening goals for different ranges of local contrast.

K′·Δ1 defines a sharpening curve. Using different functions to define K′ for different ranges of magnitude of local contrast, Δ1, provides different curve segments. The different functions may be configured so that the sharpening curve is continuous with continuous derivatives (so that small changes in local contrast do not result in large changes in sharpening). The sharpening functions may be configured so that the sharpening curve always provides increasing sharpening with increasing local contrast. Exemplary sharpening curve segments are described below.

A sharpening curve may include a noise suppression segment that is configured to suppress sharpening associated with noise. Noise may dominate or be more pronounced in areas of low local contrast. It is generally undesirable to amplify such noise through sharpening. To reduce the amplification of noise, the noise suppression segment may be designed to minimize sharpening of local contrasts whose magnitudes are below a noise suppression local contrast threshold. This noise suppression local contrast threshold may be different for different imaging systems and may be predetermined experimentally. The noise suppression segment may be defined by a noise suppression sharpening function configured to provide relatively little sharpening for very low contrast values while being continuous with a sharpening function applied to contrast values at and/or above the noise suppression local contrast threshold.

A sharpening curve may include a tissue-targeting sharpening segment configured for sharpening features of interest in the image, such as tissue. A tissue-targeting sharpening segment can apply to local contrast magnitudes in the range from the noise suppression local contrast threshold up to a second threshold value. The second threshold value may be selected based on an expectation of likely maximum local contrast associated with imaging of tissue. Optionally, the tissue-targeted sharpening segment can be applied to all local contrast values above the noise suppression local contrast threshold (i.e., up to the maximum possible local contrast value).

A sharpening curve may include a high-contrast sharpening segment for attenuating sharpening for local contrast values that are above an upper threshold of local contrast magnitudes to which the tissue-targeting sharpening function is applied. The high-contrast sharpening segment can attenuate (relative to the tissue-targeting sharpening curve) the sharpening of high local contrasts that may be associated with already sharp features in the image, such as edges of tools, specular reflections, and other high contrast features often appearing in medical images. Since over-sharpening of such already-sharp features may result in unnatural appearances, the high-contrast sharpening segment may tone down the sharpening of such already sharp features relative to the sharpening applied by the tissue-targeting segment. The high-contrast sharpening segment may apply to local contrasts above a high-contrast sharpening threshold and may apply for local contrast magnitudes up to the maximum possible local contrast or may apply for local contrast magnitudes up to an upper threshold.

A sharpening curve may include a fourth sharpening segment that may be used for local contrast magnitudes that are above an upper local contrast threshold for the high-contrast sharpening function. This fourth sharpening segment may be used to ensure that sharpening is not attenuated too much at the very high end of local contrast.

A sharpening curve may include any number of sharpening segments, including one or more of those discussed above and/or additional segments for ranges of local contrast that are between the ranges discussed above. One or more sharpening curves or curve segments may be defined by functions that include settable factors that may effectively eliminate application of a given curve segment. For example, a tissue-targeted sharpening function may include a user adjustable factor that allows the user to adjust how much sharpening is applied, and a given value of the factor may result in the maximum possible sharpening being achievable by the tissue-targeting curve segment such that the high-contrast sharpening segment is not used.

As noted above, the sharpening factor, K′, can be defined according to a plurality of different functions. As such, step 204 can include, at step 210, determining the amount of sharpening based on a plurality of different sharpening functions. For example, the following function can be used to define the sharpening factor for the noise-suppression sharpening curve segment:

$${f}_{1} = A \frac{K}{( {x}_{1} \sqrt{gain} )} ( Δ I )$$

where ƒ₁ defines the sharpening factor (K′ in equation (1) above) for local contrast magnitudes below a noise threshold local contrast value. Thus, the sharpening function defining the noise-suppression curve segment is ƒ₁·Δ1.

The value for the coefficient A scales the sharpening factor for a given bit depth. Gain is the total multiplicative factor of digital and analog gain applied to the image. Gain may be a function of one or more fixed gain parameters and/or one or more adjustable gain parameters. Gain or one or more factors of gain may be different for different images, such as where digital gain is adjusted by the user and/or imaging system to achieve desirable brightness levels. Gain or one or more factors of gain may be dynamically updated by the imaging system for each image. The coefficient K can incorporate one or more normalizing factors and/or a user adjustable global sharpening factor that can allow a user to set how much sharpening the user wants applied to the image.

x₁ is associated with the upper limit of local contrasts that are expected to be significantly influenced by noise. Since noise is generally a function of gain in the imaging system and gain can be variable, the noise suppression local contrast threshold that defines the upper limit of local contrast magnitudes to which the noise suppression sharpening function applies may be a function of gain. For example, the noise threshold local contrast value can be x₁\sqrt{gain} such that ƒ₁ is applied to all local contrasts that are less than (and, optionally, including) x₁\sqrt{gain}. x₁ can be thought of as associated with the gain-independent contributors to local contrast noise and may be different for different imaging systems, as noise is generally a function of the imaging sensor(s) and signal processing electronics. X₁ may be experimentally determined. An example of x₁ is 32 on a 12-bit scale. However, this is merely an example and is not intended to be limiting.

K, x₁, and gain are each fixed values for a given image, so ƒ₁ resolves to a linear function of the local contrast. Use of this function results in a non-linear (exponential) sharpening curve segment since the sharpening factor (ƒ₁) is multiplied by a given local contrast (ƒ₁·Δ1) to obtain the sharpening for local contrast magnitudes up to the noise suppression local contrast threshold.

The sharpening factor for a tissue-targeting sharpening curve segment may be defined according to the following exemplary function:

$${f}_{2} = A \cdot K$$

This function resolves to a fixed value, resulting in a linear sharpening function (ƒ₂·Δ1=Δ·K·Δ1) defining the tissue-targeting sharpening curve segment. Thus, the tissue-targeting sharpening curve segment defined by ƒ₂ is a linear segment. ƒ₂ may be used for local contrast magnitudes that are above the noise suppression local contrast threshold. Note that at the noise suppression local contrast threshold, where Δ1=x₁ \sqrt{gain}, both ƒ₁ and ƒ₂ resolve to A·K such that the sharpening curve is continuous with continuous derivatives.

The sharpening factor for a high-contrast sharpening curve segment may be defined by the following exemplary function:

$${f}_{3} = A ( \sqrt{{sharppoint}_{2} ( 8 Δ I - 7 {sharppoint}_{2} )} + 3 {sharppoint}_{2} ) \frac{K}{4 Δ I} where , {sharppoint}_{2} = {y}_{1} \sqrt{\frac{{Z}_{1}}{2 K}}$$

Thus, the sharpening function defining the high-contrast sharpening curve segment, ƒ₃·Δ1, is a non-linear function. The parameters y₁ and z₁ are tunable parameters that control where the high-contrast sharpening curve segment starts and stops and the degree to which it attenuates sharpening of high contrast features. These parameters may be pre-determined experimentally for a given imaging system. ƒ₃ applies for b<|Δ1|<c, where b is the high-contrast sharpening threshold and is the local contrast magnitude where:

$${f}_{3} = A \cdot K$$

The high-contrast sharpening upper threshold, c, can be the maximum possible local contrast magnitude or can be the local contrast where:

$${f}_{3} = A \cdot \frac{{z}_{1}}{2}$$

When c is less than the maximum possible local contrast magnitude, a fourth curve segment may be used, such as defined by the following function:

$${f}_{4} = A \cdot {z}_{1}$$

Depending on the choice for x₁, y₁, and Z₁, and the settings for gain and K, one or more of the segments described above may not apply. For example, where x₁, y₁, Z₁, gain, and K have values such that b is less than the noise suppression local contrast threshold (x₁ \sqrt{gain}), the tissue-targeting sharpening segment may be skipped and sharpening may transition directly from the noise suppression sharpening curve segment to the high-contrast sharpening curve segment.

The sharpening curve segments described above can be implemented by applying the function corresponding to the given local contrast magnitude. Alternatively, the sharpening curve segments can be implemented using look-up tables, with different look-up tables provided for different values of gain and global sharpening factor K.

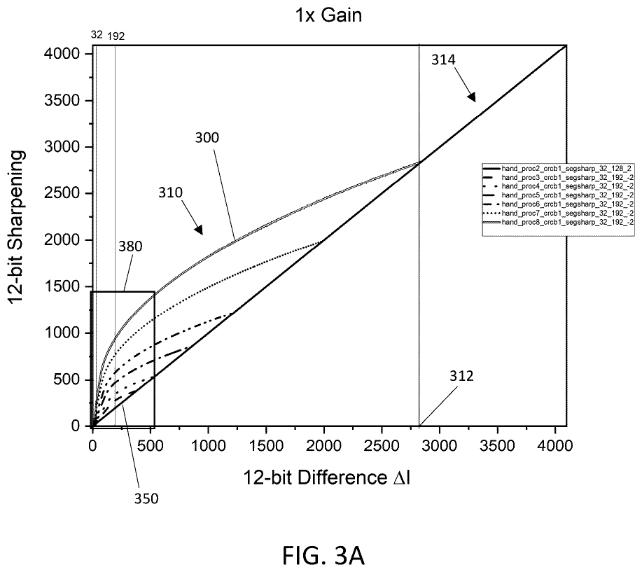

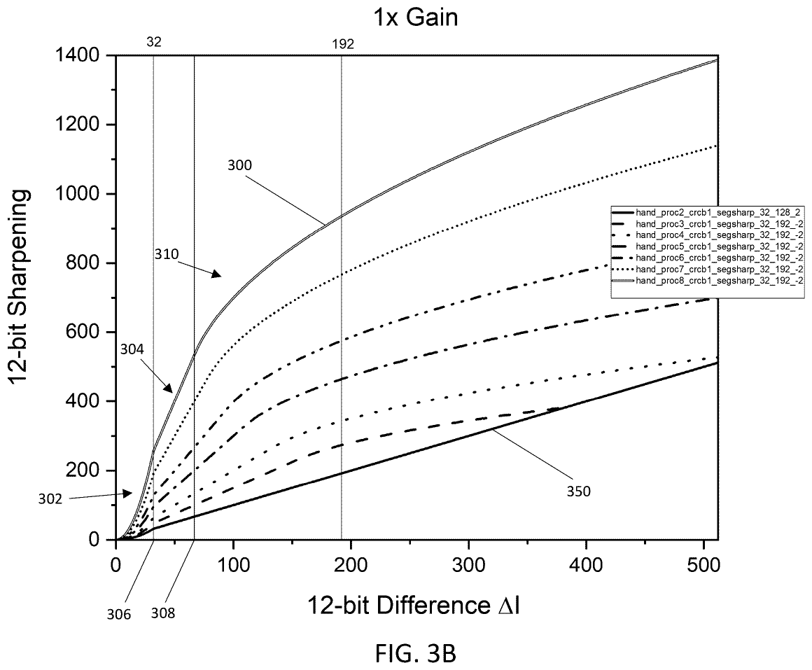

FIGS. 3A and 3B illustrate a family of sharpening curves, where the x-axis is the local contrast magnitude on a 12-bit scale (0 to 4096) and the y-axis is the value of the product of the sharpening factor and the local contrast magnitude (K′·|Δ1|), with the sharpening factor K′ determined according to the functions and parameters described above. Each of the seven different curves is associated with a different global sharpening factor K. FIG. 3A shows the entire scale, and FIG. 3B is a zoomed-in view of the lower end of the scale-region 380 of FIG. 3A. Each curve is associated with a different global sharpening setting, K. The gain, x₁, y₁, Z₁ are the same for all of the curves in FIGS. 3A and 3B.

Sharpening curve 300 is associated with the maximum global sharpening factor for the illustrated set of curves and curve 350 is associated with the minimum global sharpening factor for the illustrated set of curves. The noise-suppression curve segment 302 and tissue-targeting curve segment 304 of curve 300 are best seen in FIG. 3B. The noise-suppression curve segment 302 controls the sharpening for local contrasts having magnitudes from 0 to the noise-suppression local contrast threshold 306, which in the illustrated example is 32. The tissue-targeting curve segment 304 controls the sharpening for local contrasts having magnitudes ranging from the noise-suppression local contrast threshold 306 to a high-contrast sharpening threshold 308. Comparing the noise-suppression curve segment 302 and tissue-targeting curve segment 304, the noise-suppression curve segment provides relatively less sharpening than would be provided by using the sharpening function that defines the tissue-targeting curve segment. This provides the benefit of combining relatively less sharpening of noise with sufficient sharpening of areas of interest, such as tissue.

The tissue-targeting curve segment 304 transitions to a high-contrast sharpening curve segment 310 at the high-contrast sharpening threshold 308. The slope of the sharpening curve 300 decreases with increasing local contrast in the high-contrast sharpening curve segment 310, which has the effect of attenuating sharpening of high contrast features, such as tools and specular reflections.

Referring to FIG. 3A, the high-contrast sharpening curve segment 310 continues to an upper threshold 312. At the upper threshold 312, the high-contrast sharpening curve segment 310 transitions to a fourth segment 314 that is associated with a minimum level of sharpening.

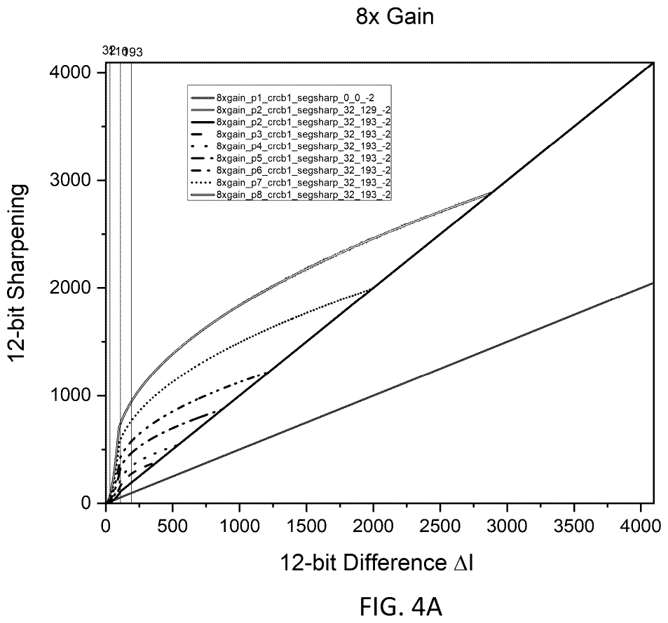

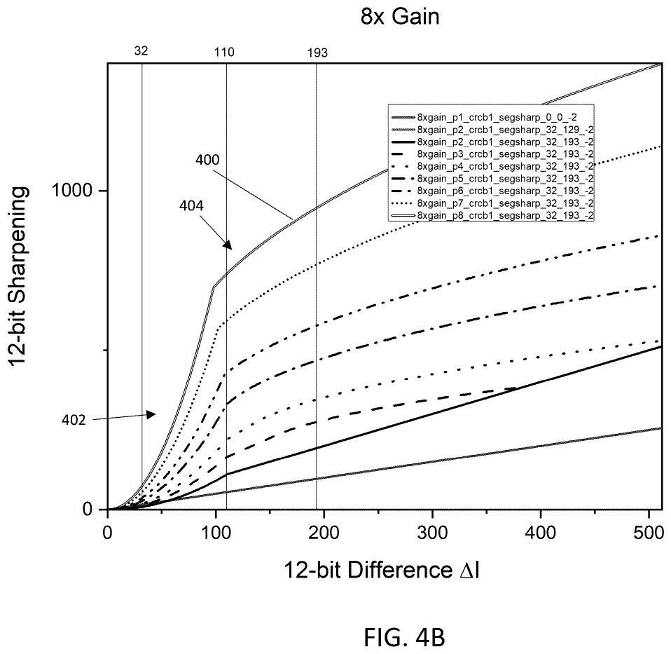

FIGS. 4A and 4B show a set of curves generated from the functions described above using a higher gain value than the gain value used for the curves of FIGS. 3A and 3B. Looking at the lower end of the set of curves, shown in more detail in FIG. 4B, the noise-suppression curve segments (e.g., segment 402 of curve 400) apply to a greater range of local contrast magnitudes than the noise-suppression curve segments (e.g., segment 302 of curve 300) of FIGS. 3A and 3B. This is because the noise-suppression local contrast threshold is a function of gain, which is higher for the curves in FIGS. 4A and 4B than for the curves in FIGS. 3A and 3B.

Returning to FIG. 2, the amount of sharpening as a function of local contrast (i.e., K′·Δ1) determined at step 210 can be applied to the original luminance image at step 212 to generate a sharpened luminance image. The sharpened medical image can then be generated by converting from the luminance-chrominance color space to, for example, the RGB color space using the sharpened luminance image. Method 200 may include, at optional step 214, displaying the sharpened medical image, such as on one or more displays 118 of system 100. The sharpened medical image may be displayed as a single snapshot image or as a frame of a video feed to assist a user (e.g., surgeon or other medical practitioner) in visualizing imaged tissue. Additionally or alternatively, the sharpened medical image may be combined with other imaging data, such as fluorescence imaging data, into a combined image that may be displayed to a user. The sharpened medical image may be used in any other way that medical images may be used. For example, the sharpened medical image may be used as training data for training one or more machine learning models, such as to automatically identify tissue or attributes of tissue in the sharpened medical image.

Returning to step 212, the amount of sharpening may be applied to the original luminance image in different ways to achieve the sharpened luminance image. For example, the sharpened luminance image can be generated by adding or subtracting the amount of sharpening from the original luminance image, as follows:

$${Image}_{Sharp} = {Image}_{0} + {K}^{′} \cdot Δ I \qquad ( 2 )$$

For a pixel with a positive local contrast (the luminance of the pixel in the original luminance image is greater than the corresponding blurred image value, such as for the bright side of an edge), the amount of sharpening is added to the pixel value of the original luminance image to arrive at the corresponding pixel value in the sharpened luminance image. For a pixel with a negative local contrast (the luminance of the pixel in the original luminance image is less than the corresponding blurred image value, such as for the dark side of an edge), the amount of sharpening is subtracted from the pixel value of the original luminance image to arrive at the corresponding pixel value in the sharpened luminance image.

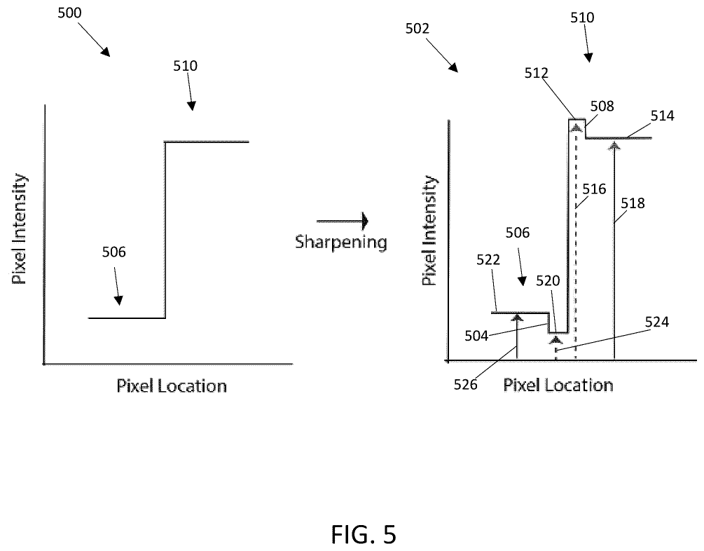

According to equation (2), the same amount is subtracted from the dark side of an edge as is added to the light side of an edge. This is illustrated in FIG. 5, which shows a simplistic representation of the dark and light sides of an edge in the original luminance image 500 and the sharpened luminance image 502. The amount 504 subtracted from the dark side 506 is the same as the amount 508 added to the light side 510. This can be problematic because of how human vision perceives differences in luminance. Human vision does not respond to absolute values of luminance difference. Instead, it responds to the relative difference in luminance between two areas. Comparing the dark side 506 and the light side 510 of the edge in the sharpened luminance image 502, it can be seen that on the light side 510, the relative difference in brightness between a sharpened part 512 (overshoot) and a non-sharpened part 514 of the edge is small (arrows 516 and 518 are similar in size), while on the dark side 506, the relative difference between a sharpened part 520 (undershoot) and a non-sharpened part 522 of the edge is large (arrow 524 is about half the size of arrow 526). Human vision will generally perceive the difference between the sharpened part 520 and non-sharpened part 522 of the dark side 506 as larger than the difference between the sharpened part 512 and non-sharpened part 514 of the light side 510.

Sharpening can be made more perceptually symmetric by using different functions for applying the sharpening to the bright and dark sides of an edge. For example, equation (2) can be used for sharpening the bright side of an edge, and the following equation can be used for sharpening the dark side of an edge:

$${Image}_{Sharp} = \frac{{Image}_{0}^{2}}{{Image}_{0} - {K}^{′} \cdot Δ I} \qquad ( 3 )$$

Equation (3) reduces the relative amount of undershoot (subtraction from the dark side of an edge) so that the ratio of the sharpened and non-sharpened portions of a dark side of an edge is similar to the ratio of the sharpened and non-sharpened portions of a bright side of an edge. Thus, the function used for applying the amount of sharpening for negative local contrasts is different than the function used for applying the amount of sharpening for positive local contrasts. The different functions may be proportional to one another.

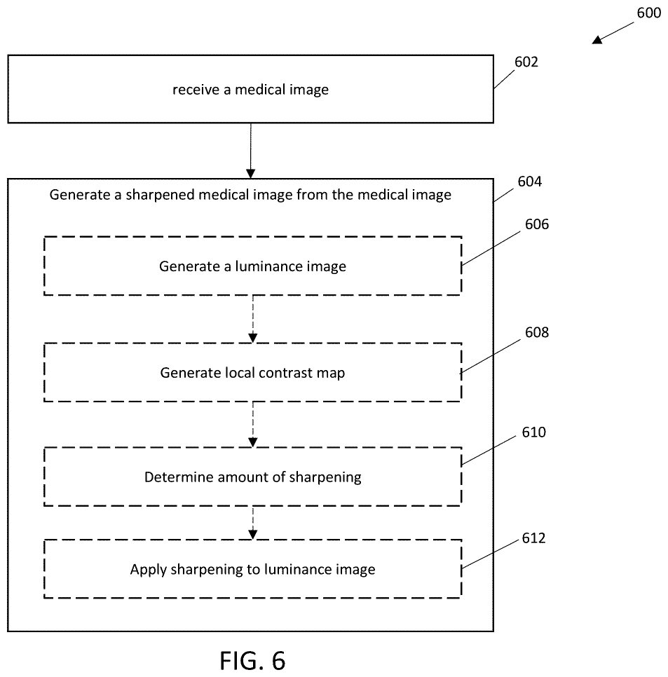

FIG. 6 is a flow diagram of a method 600 for sharpening a medical image using different functions for applying sharpening to the bright and dark sides of edges in the medical image. Method 600 may be performed by an imaging processing system, such as image processing unit 116 of system 100. At step 602, a medical image is received. This step is analogous to step 202 of method 200 of FIG. 2, and thus, the details of this step are not repeated here for simplicity.

At step 604, a sharpened medical image is generated. Generating the sharpened medical image can include generating a luminance image at step 606, generating the local contrast map (the set of local contrasts for each pixel of the luminance image) at step 608, and determining an amount of sharpening at step 610. As discussed above, the amount of sharpening is computed for each pixel of the medical image based on the local contrast associated with the pixel and a sharpening curve that can be based on at least one sharpening function. The amount of sharpening can be computed according to the sharpening curves discussed above with respect to method 200. Alternatively, the amount of sharpening can be computed using a conventional sharpening function that uses a curve with constant slope for the full range of local contrasts (i.e., the sharpening value is equal to the product of a constant sharpening factor and the local contrast).

At step 612, the amount of sharpening is applied to the luminance image using different functions for positive local contrasts and negative local contrasts. If the local contrast for a given pixel (a signed difference between a luminance for the pixel and a blurred luminance for the pixel) is a positive value (e.g., the pixel is on the bright side of an edge), the sharpening value for the given pixel is used to increase the luminance (brightness) of the given pixel by a first amount associated with the sharpening value to generate the sharpened luminance value for the given pixel. For example, using equation (2), sharpening value (K′·Δ1) can be added to the original luminance of the given pixel to arrive at the sharpened luminance for the given pixel.

If, however, the local contrast for the given pixel is a negative value (e.g., the pixel is on the dark side of an edge), the sharpening value for the given pixel is used to decrease the luminance of the given pixel by a second amount associated with the sharpening value to generate the sharpened luminance value for the given pixel, where the second amount is less than the first amount would have been had the local contrast been positive. This can be done, for example, using equation (3). Thus, the decrease in luminance of a dark side of an edge is proportional to and less than the increase in the luminance of a bright side of an edge, which may provide a more perceptually symmetric sharpened image.

Optionally, where sharpening is performed on the luminance channel of the image, the sharpened medical image is generated by converting from the luminance-chrominance color space to the RGB color space or any other suitable color space.

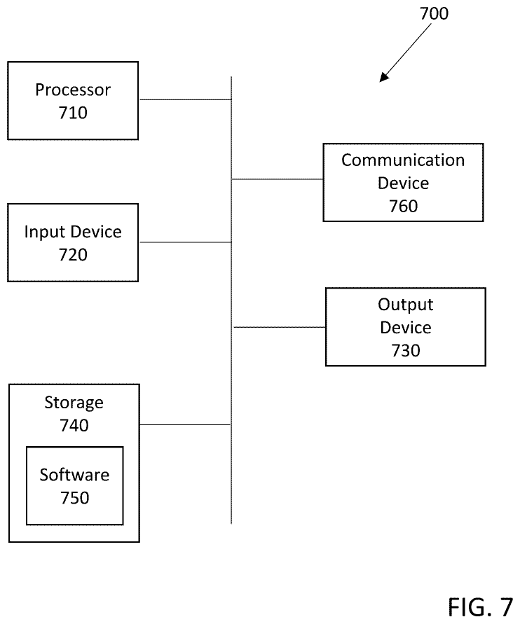

FIG. 7 illustrates an example of a computing system 700 that can be used for one or more of the components of system 100 of FIG. 1, such as one or more of camera head 108, camera control unit 112, image processing unit 116, and illuminator 120. System 700 can be a computer connected to a network, such as one or more networks of hospital, including a local area network within a room of a medical facility and a network linking different portions of the medical facility. System 700 can be a client or a server. As shown in FIG. 7, system 700 can be any suitable type of processor-based system, such as a personal computer, workstation, server, handheld computing device (portable electronic device) such as a phone or tablet, or dedicated device. The system 700 can include, for example, one or more of input device 720, output device 730, one or more processors 710, storage 740, and communication device 760. Input device 720 and output device 730 can generally correspond to those described above and can either be connectable or integrated with the computer.

Input device 720 can be any suitable device that provides input, such as a touch screen, keyboard or keypad, mouse, gesture recognition component of a virtual/augmented reality system, or voice-recognition device. Output device 730 can be or include any suitable device that provides output, such as a display, touch screen, haptics device, virtual/augmented reality display, or speaker.

Storage 740 can be any suitable device that provides storage, such as an electrical, magnetic, or optical memory including a RAM, cache, hard drive, removable storage disk, or other non-transitory computer readable medium. Communication device 760 can include any suitable device capable of transmitting and receiving signals over a network, such as a network interface chip or device. The components of the computing system 700 can be connected in any suitable manner, such as via a physical bus or wirelessly.

Processor(s) 710 can be any suitable processor or combination of processors, including any of, or any combination of, a central processing unit (CPU), graphics processing unit (GPU), field programmable gate array (FPGA), and application-specific integrated circuit (ASIC). Software 750, which can be stored in storage 740 and executed by one or more processors 710, can include, for example, the programming that embodies the functionality or portions of the functionality of the present disclosure (e.g., as embodied in the devices as described above). For example, software 750 can include one or more programs for execution by one or more processor(s) 710 for performing one or more of the steps of method 200 and/or method 600.

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for sharpening a medical image comprising:
receiving the medical image; and
generating a sharpened medical image from the medical image using at least:
a first sharpening function for at least some areas of local contrast magnitude in the medical image that are below a first local contrast magnitude threshold for suppressing sharpening of noise-based contrast,
a second sharpening function for at least some areas of local contrast magnitude in the medical image that are between the first local contrast magnitude threshold and a second local contrast magnitude threshold, and
a third sharpening function for at least some areas of local contrast magnitude in the medical image that are above the second local contrast magnitude threshold for attenuating sharpening relative to the second sharpening function.

2. The method of claim 1, wherein the first, second, and third sharpening functions are used for sharpening a luminance channel of the medical image.

3. The method of claim 1, wherein the local contrast magnitude comprises an absolute value of a difference between a luminance and a blurred luminance.

4. The method of claim 1, wherein the second sharpening function is a linear function.

5. The method of claim 4, wherein the first and third sharpening functions are non-linear functions.

6. The method of claim 1, wherein at least one of the first sharpening function, the second sharpening function, and the third sharpening function comprises a user defined sharpening factor.

7. The method of claim 6, wherein each of the first sharpening function, the second sharpening function, and the third sharpening function comprises the user defined sharpening factor.

8. The method of claim 1, wherein the first sharpening function comprises a gain factor that corresponds to gain applied for generating the medical image.

9. The method of claim 1, wherein the sharpened medical image is generated using a fourth sharpening function for areas of local contrast magnitude that are above a third local contrast magnitude threshold that is higher than the second local contrast magnitude threshold.

10. The method of claim 1, wherein the second local contrast magnitude threshold is associated with attenuating sharpening of at least one of specular reflections and medical instruments.

11. The method of claim 1, comprising, for a respective pixel of the medical image:
computing a sharpening value based on a local contrast associated with the respective pixel and the first, second, or third sharpening function;
in accordance with the local contrast being positive, using the sharpening value to increase a brightness value for the respective pixel by a first amount; and
in accordance with the local contrast being negative, using the sharpening value to decrease the brightness value for the respective pixel by a second amount that is less than the first amount would have been had the local contrast been positive.

12. A method for sharpening a medical image comprising:
receiving the medical image; and
generating a sharpened medical image, wherein generating the sharpened medical image comprises, for each pixel of the medical image:
computing a sharpening value for the respective pixel based on a local contrast associated with the respective pixel and at least one sharpening function,
in accordance with the local contrast being positive, using the sharpening value for the respective pixel to increase a brightness value for the respective pixel by a first amount, and
in accordance with the local contrast being negative, using the sharpening value for the respective pixel to decrease the brightness value for the respective pixel by a second amount that is less than the first amount would have been had the local contrast been positive.

13. The method of claim 12, wherein the local contrast associated with the respective pixel comprises a signed difference between a luminance and a blurred luminance.

14. The method of claim 12, wherein the at least one sharpening function comprises multiple sharpening functions, each used for a different range of local contrasts.

15. The method of claim 12, wherein the brightness value is a brightness value for a luminance channel of the medical image.

16. The method of claim 12, wherein the first amount is defined by a first function and the second amount is defined by a second function that is different than and proportional to the first function.

17. The method of claim 16, wherein the second amount is proportional to the local contrast and to the original brightness value for the respective pixel.

18. The method of claim 12, wherein a brightness value for a sharpened image pixel associated with a negative local contrast is a quotient of: (a) the square of a corresponding brightness value of the medical image, and (b) a difference between the corresponding brightness value of the medical image and the sharpening value.

19. The method of claim 18, wherein a brightness value for a sharpened image pixel associated with a positive local contrast is the sum of the sharpening value and a corresponding brightness value of the medical image.

20. A system for sharpening a medical image, the system comprising one or more processors, memory, and one or more programs stored in the memory for execution by the one or more processors, wherein the one or more programs include instructions that when executed by the one or more processors cause the system to:
receive the medical image; and
generate a sharpened medical image from the medical image using at least:
a first sharpening function for at least some areas of local contrast magnitude in the medical image that are below a first local contrast magnitude threshold for suppressing sharpening of noise-based contrast,
a second sharpening function for at least some areas of local contrast magnitude in the medical image that are between the first local contrast magnitude threshold and a second local contrast magnitude threshold, and
a third sharpening function for at least some areas of local contrast magnitude in the medical image that are above the second local contrast magnitude threshold for attenuating sharpening relative to the second sharpening function.

21. The system of claim 20, wherein the first, second, and third sharpening functions are used for sharpening a luminance channel of the medical image.

22. The system of claim 20, wherein the local contrast magnitude comprises an absolute value of a difference between a luminance and a blurred luminance.

23. The system of claim 20, wherein the second sharpening function is a linear function.

24. The system of claim 23, wherein the first and third sharpening functions are non-linear functions.

25. The system of claim 20, wherein at least one of the first sharpening function, the second sharpening function, and the third sharpening function comprises a user defined sharpening factor.

26. The system of claim 25, wherein each of the first sharpening function, the second sharpening function, and the third sharpening function comprises the user defined sharpening factor.

27. The system of claim 20, wherein the first sharpening function comprises a gain factor that corresponds to gain applied for generating the medical image.

28. The system of claim 20, wherein the sharpened medical image is generated using a fourth sharpening function for areas of local contrast magnitude that are above a third local contrast magnitude threshold that is higher than the second local contrast magnitude threshold.

29. A system for sharpening a medical image, the system comprising one or more processors, memory, and one or more programs stored in the memory for execution by the one or more processors, wherein the one or more programs include instructions that when executed by the one or more processors cause the system to:
receive the medical image; and
generate a sharpened medical image, wherein generating the sharpened medical image comprises, for each pixel of the medical image:
computing a sharpening value for the respective pixel based on a local contrast associated with the respective pixel and at least one sharpening function,
in accordance with the local contrast being positive, using the sharpening value for the respective pixel to increase a brightness value for the respective pixel by a first amount, and
in accordance with the local contrast being negative, using the sharpening value for the respective pixel to decrease the brightness value for the respective pixel by a second amount that is less than the first amount would have been had the local contrast been positive.

30. The system of claim 29, wherein the local contrast associated with the respective pixel comprises a signed difference between a luminance and a blurred luminance.

31. The system of claim 29, wherein the at least one sharpening function comprises multiple sharpening functions, each used for a different range of local contrasts.

32. The system of claim 29, wherein the brightness value is a brightness value for a luminance channel of the medical image.

33. The system of claim 29, wherein the first amount is defined by a first function and the second amount is defined by a second function that is different than and proportional to the first function.

34. The system of claim 33, wherein the second amount is proportional to the local contrast and to the original brightness value for the respective pixel.
